(19) United States
(12) Patent Application Publication
(10) Pub. No.: US 2005/0182190 A1
(43) Pub. Date: Aug. 18, 2005

(54) Mixtures of alkylated and non-alkylated cellulose ethers and use thereof

(75) Inventors: Eckart Kraemer, Wiesbaden (DE); Heiko Galler, Hahnheim (DE); Uwe Falk, Bruchkoebel (DE)

Correspondence Address: Richard S Roberts;Roberts & Roberts, P O Box 484, Princeton, NJ, 08542, US

(73) Assignee: SE Tylose GmbH & Co. KG, D65203 Wiesbaden (DE)

(21) Appl. No.: 10/515,367

(22) PCT Filed: Jul. 17, 2003
(86) PCT No.: PCT/EP03/07749

(30) Foreign Application Priority Data
Jul. 31, 2002 (DE) 102 34 840.5
Nov. 14, 2002 (DE) 102 52 970.1

(51) Int. Cl. C08G 63/48; C08G 63/91

(52) U.S. Cl. 525/54.2; 526/200

(57) ABSTRACT

The invention relates to mixtures of cellulose ethers, comprising A) allyl-modified cellulose ethers of formula (1) where C₆H₇O₂ is one anhydroglucose unit, n is from 50 to 1600, R¹, R² and R³ independently of one another are a polyalkylene oxide chain of the formula (2), with X=H, CH₃, C₂H₅ or CH₂CH═CH₂ and in which p, q and r independently of one another, in R¹, R² and R³ each independently, can adopt values from 0 to 4, the sum (p+q+r) added over R¹, R² and R³ per anhydroglucose unit is on average more than 1.3 and less than 4.5, the sequence of the oxyalkyl units in the polyalkylene oxide chain is arbitrary and the average number of —CH₂CH═CH₂— groups per anhydroglucose unit is from 0.01 to 0.1, and B) cellulose ethers of formula (3) where C₆H₇O₂ is one anhydroglucose unit, n is from 50 to 1600, R⁴, R⁵ and R⁶ independently of one another are a polyalkylene oxide chain of formula (4) where Y=H, CH₃ or C₂H₅ and in which p, q and r independently of one another, in R⁴, R⁵ and R⁶ each independently, can adopt values of 0 to 4, the sum (p+q+r) added over R⁴, R⁵ and R⁶ per anhydroglucose unit is on average more than 1.3 and less than 4.5, and the sequence of the oxyalkyl units in the polyalkylene oxide chain is arbitrary, in an A:B mixing ratio of from 1:99 to 99:1 by weight.

The preparation of vinyl polymers by free-radical addition polymerization in an aqueous, solvent-free medium necessitates emulsification of the hydrophobic monomers and, after polymerization has taken place, stabilization of the polymer. Required for this purpose are not only surfactants but also protective colloids, which on the one hand possess a hydrophilic nature and on the other hand also exhibit a dispersing action. Polymeric carbohydrates such as starch, dextrans and water-soluble cellulose derivatives are known as suitable protective colloids for water-based polymerization systems. The protective colloid most frequently deployed in the commercial preparation of polyvinyl acetate and copolymers is hydroxyethylcellulose (Cellulose and its Derivatives, chapter 26, Ellis Horwood, 1985).

The properties and quality of the polymer dispersion depend critically on the choice of protective colloid, which may vary in a number of physical variables such as molecular weight, type and degree of substitution, etc. Important polymer dispersion quality criteria affected by protective colloids are for example the viscosity, rheology, particle size, coagulum, water absorption by the resultant film, and the molecular weight of the polymer. Deployment also enhances the dispersion's stability to external influences such as transport, handling, conveying, raises the stability toward temperature fluctuation, and lessens the sensitivity to additives such as pigments, for example.

A key process when protective colloids are used in emulsion polymerization is seen as being the formation of free radicals on the protective colloid and subsequent grafting of the monomer onto the colloid. The grafting rate depends not only on the free-radical initiator but also on the identity and concentration of the protective colloid. The protective colloid effect increases with increasing amount deployed, but such increase is undesirable on cost grounds and from a performance standpoint (water absorption by the film). Improvement in grafting is expected from protective colloids which contain unsaturated and hence polymerizable groups, which then enables there to be not only physical adsorption but also covalent bonding to the particle material. SU-14 848 14 discloses the possibility of vinyl acetate grafting of allyl-containing cellulose derivatives having a degree of substitution with allyl ether groups of from 0.04 to 0.3 and a degree of polymerization of from 1000 to 1200. Protective colloids having such high degrees of polymerization, however, tend to be less suitable in polymerization systems, since the high viscosities entail stirring and conveying problems.

EP-0 541 939 B1 discloses polymeric cellulose derivatives which contain allyl glycidyl ether and which at a degree of substitution of from 0.05 to 0.5 allyl glycidyl groups per monomeric carbohydrate unit are likewise polymerizable. The addition of carbohydrates modified in this way enhances the scrub resistance of coating materials.

Polymerizable methylhydroxypropylcellulose ethers containing alkenyl groups, and their use in the production of films and coatings, are disclosed in EP 0 457 092 B1. The molar degree of substitution is reported to be 0.05 to 1.0.

In EP 0 863 158 A2 (=U.S. Pat. No. 5,994,531) it is disclosed that with water-soluble, nonionic cellulose ethers from the group of the alkylcelluloses and hydroxyalkylcelluloses, with an average degree of polymerization of less than 900, substituted on average by from 0.01 to 0.04 2-propenyl groups per anhydroglucose unit (AM-HEC), it is possible using a substantially smaller amount of protective colloid to prepare aqueous polymer dispersions of at least equal quality as set against conventional protective colloids not containing 2-propenyl groups (usually hydroxyethylcellulose (HEC)). The properties possessed by the dispersions are different from those of dispersions prepared using HEC (e.g., viscosity, water absorption by the film, particle size, Theological behavior). AM-HEC is therefore used preferably in original formulations.

An underlying object was to find compositions of polymer dispersions which especially when employed as a protective colloid allow the amount used to be reduced.

Surprisingly it has been found that blends of the HEC commonly used as protective colloid with AM-HEC permit a reduction in the overall amount used without gravely affecting the properties of the resulting polymer dispersion. Additionally it was possible to show that hydroxyethylcelluloses with relatively high degrees of allyl modification, in a mixture with hydroxyethylcellulose, and with the amount used reduced, lead likewise to high-quality dispersions.

The invention provides mixtures of cellulose ethers, comprising
A) allyl-modified cellulose ethers of formula (1)
   [C₆H₇O₂(OR¹)(OR²)(OR³)]ₙ (1)
   where
C₆H₇O₂ is one anhydroglucose unit
n is from 50 to 1600
R¹, R² and R³ independently of one another are a polyalkylene oxide chain of the formula (2) 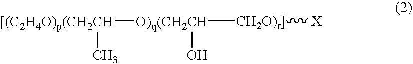
   where X=H, CH₃, C₂H₅ or CH₂CH═CH₂
   and in which
p, q and r independently of one another, in R¹, R² and R³ each independently, can adopt values from 0 to 4, the sum (p+q+r) added over R¹, R² and R³ per anhydroglucose unit is on average more than 1.3 and less than 4.5, the sequence of the oxyalkyl units in the polyalkylene oxide chain is arbitrary and the average number of —CH₂CH═CH₂— groups per anhydroglucose unit is from 0.01 to 0.1, and
B) cellulose ethers of formula (3)
   [C₆H₇O₂(OR¹)(OR²)(OR³)]ₙ (3)
   where
C₆H₇O₂ is one anhydroglucose unit,
n is from 50 to 1600,
R⁴, R⁵ and R⁶ independently of one another are a polyalkylene oxide chain of formula (4) 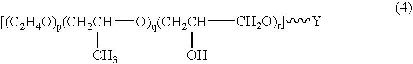
   where Y=H, CH₃ or C₂H₅ and in which
   p, q and r independently of one another, in R⁴, R⁵ and R⁶ each independently, can adopt values of 0 to 4, the sum (p+q+r) added over R⁴, R⁵ and R⁶ per anhydroglucose unit is on average more than 1.3 and less than 4.5, and the sequence of the oxyalkyl units in the polyalkylene oxide chain is arbitrary, in an A:B mixing ratio of from 1:99 to 99:1 by weight.

The invention further provides for the use of the mixtures of the composition indicated above as a protective colloid in aqueous emulsion polymerization.

The invention further provides a process for implementing an aqueous emulsion polymerization, where a mixture as defined above is added as protective colloid.

The degrees of polymerization n in formulae 1 and 3 can be the same or they can be different values n₁ and n₂. In this case the ranges of values applying to n₁ and n₂ are those disclosed for n.

The stoichiometric indices p, q and r in formulae 1 and 3 can be identical or they can be different values P₁, q₁ and r₁ and P₂, q₂ and r₂. In this case the ranges of values applying to P₁, q₁, and r₁ and P₂, q₂ and r₂ are those disclosed for p, q and r.

In formulae 1 and 3 n is preferably a number from 100 to 700, in particular from 140 to 500, especially from 160 to 300.

The sum (p+q+r), as defined above, is preferably, for constituents A) and B) independently of one another, between 1.5 to 3.0.

In formula 1 the average number of allyl groups (—CH₂CH═CH₂— groups) per anhydroglucose unit is preferably from 0.02 to 0.04.

Preferred mixtures of cellulose ethers comprise for example the 2-propenyl ethers of
hydroxyethylcellulose (1.3<p<4.5; q=0; r=0),
hydroxypropylcellulose (p=0; 1.3<q<4.5; r=0),
dihydroxypropylcellulose (p=0; q=0; 3<r<4.5),
the degree of alkylation being 0.03,
in a mixture with cellulose ethers having the same features but without 2-propenyl ether substitution, the mixing ratio being 1:2.

The mixing ratio between constituents A and B is preferably between 10:90 and 90:10, and in particular is 1:1.

The inventive mixtures of cellulose ethers can be used as a protective colloid in emulsion polymerizations. In the emulsion polymerization they stabilize the polymer dispersions which form.

The amount of the inventive cellulose ethers used when preparing such polymer dispersions is preferably from 0.2 to 5.0% by weight, in particular from 0.3 to 1.0% by weight, based on the total amount of the monomers used.

Suitable monomers for the emulsion polymerization are ethylenically unsaturated, free-radically polymerizable compounds which per se are insoluble in water, examples being simple ethylenically unsaturated hydrocarbons having chain lengths of 2 to 12 carbon atoms, preferably ethylene and propylene; esters having chain lengths of between 2 and 12 carbon atoms and of acrylic, methacrylic, maleic, fumaric or itaconic acid, preferably ethyl, propyl and butyl esters; vinyl esters of unbranched and branched carboxylic acids having chain lengths of 1 to 12 carbon atoms, especially vinyl acetate and Versatic acid vinyl esters; ethylenically unsaturated aromatic compounds, preferably styrene; ethylenically unsaturated aldehydes and ketones having 3 to 12 carbon atoms, preferably acrolein, methacrolein and methyl vinyl ketone, halogenated ethylenically unsaturated compounds, vinyl chloride for example.

Particular preference is given to mixtures of the monomers stated in which at least one component is a vinyl ester, preferably vinyl acetate. It is also possible to use mixtures of one or more of the stated monomers with hydrophilic monomers, examples being acrylonitrile, acrylic acid, methacrylic acid, itaconic acid or anhydrides thereof.

Preferably an aqueous polymerization formula in which the inventive cellulose ethers are used as protective colloids contains from 10 to 70% by weight, preferably from 30 to 60% by weight, of the abovementioned monomers and also from 0 to 10% by weight of one or more emulsifiers. Free-radical initiators used are usually diazo compounds, redox initiators, organic or inorganic peroxo compounds in amounts of from 0.1 to 3% by weight, preferably from 0.5 to 1% by weight, based on the total amount of the monomers. Further auxiliaries, examples being buffer substances or preservatives, can be added.

All of the components can be introduced together at the beginning of the reaction, with the monomer or monomer mixture being emulsified by stirring or by means of other mixing equipment. Raising the temperature starts off the polymerization process. The required temperatures are dependent on the initiator system used and amount to between 40 and 120° C. After the onset of the reaction the heat it gives off may also necessitate cooling. The end of the reaction is evident from a subsidence in the heat given off. To complete the reaction an option is to add on an afterreaction by means of external supply of heat. After cooling it is possible to add auxiliaries for setting a pH, such as buffers, acids or bases, for example, or for stabilizing, preservatives for example. Optionally the polymerization can also be initiated with a fraction, from 10 to 20% by weight for example, of the quantity of monomer and free-radical initiator, and further monomer and free-radical initiator can be metered in after onset of the reaction, preferably in such a way that the desired polymerization temperature is controlled by the addition. This technique produces main-chain polymers and not graft polymers.

The dispersions obtained in accordance with the invention are characterized by the following properties:

Dispersion Viscosity at Low Shear Rate (1.0 s⁻¹):

For good processing properties and stability of the dispersion the desirable viscosity is preferably between 5000 and 30,000 mPas, in particular from 10,000 to 20,000.

Mean Particle Size of the Dispersion:

The mean particle size of the dispersion ought preferably to be from 200 to 300 nm (measured at a wavelength of 435 nm) in order to prevent unwanted settling of the dispersion (formation of serum).

Amount of coagulum after filtering the dispersion through a 100 μm and a 40 μm sieve, expressed in mg of coagulum per 1000 g of dispersion:

The dispersions preferably have a coagulum fraction of <200 mg/kg dispersion for 100 μm filtration and <300 mg/kg dispersion for 40 μm filtration. Water absorption by the dried polymer films:

The dispersion is poured out onto a sheet and dried to a film. Following treatment with water the water absorption (in % by weight of the intrinsic weight of the polymer film) is determined by the weight increase. The water absorption should preferably be below 25%, in particular between 5 and 20% by weight.

### EXAMPLES

The data for degrees of substitution are based in the case of hydroxyethyl groups on the molar degree of substitution (MS) and in the case of the allyl groups on the degree of substitution (DS). In both cases these values express the level of the degree of substitution of the group in question per anhydroglucose unit. The characteristic features of the cellulose ethers used are summarized in the table below.

The ®Emulsogen emulsifiers used here are surfactants from Clariant GmbH based on oxethylated fatty and/or oxo alcohols.

The parts and percentages reported in the examples are by weight unless noted otherwise. The solids content of the dispersions prepared in the examples below is approximately 55%. The following cellulose ethers were used in the examples:

TABLE 1

| | Product | Viscosity level (Höppler; | | | |
|---|---|---|---|---|---|
| No. | Tylose | 1.9% eq; absolutely dry) | MS_{EO} | DS_{allyl} | n |
| 1 | H 15 YG4 | 15 | 2.50 | — | 195 |
| 2 | H 180 YG4 | 180 | 2.50 | — | 500 |
| 3 | H 200 YG4 | 200 | 2.50 | — | 520 |
| 4 | E 89906 | 40 | 1.76 | 0.023 | 280 |
| 5 | E 80201 | 150 | 2.11 | 0.026 | 450 |
| 6 | E 80206 | 1000 | 2.43 | 0.027 | 700 |
| 7 | 97/087C | 20 | 1.72 | 0.055 | 210 |
| 8 | 97/122C | 20 | 2.15 | 0.042 | 210 |
| 9 | KR 011/00 | 3000 | 2.20 | 0.029 | 950 |
| 10 | KR 012/00 | 10000 | 2.39 | 0.029 | 1300 |

MS_{EO} corresponds to the sum p + q + r. Products 1 to 3 correspond to constituent B), products 4 to 10 to constituent A) of the mixture according to the invention.

### Example 1 (standard) Tylose H 15 YG4 (100%)

### Preparation of a Vinyl Ester Polymer Dispersion Using Hydroxyethylcellulose

The monomer mixture used is composed of 75% by weight of vinyl acetate and 25% by weight of ®VeoVa 10 (vinyl ester of a-branched C₁₀ carboxylic acids, Shell). A 2 liter reactor with plane-ground joints, lid and installed reflux condenser is charged with the following weighed substances in order:

TABLE 2

| | Amount | Amount [%] of |
|---|---|---|
| Substance | [g] | overall batch |
| Deionized water | 423.09 | 32.03 |
| Tylose H 15 YG4 (HEC) | 14.00 | 1.06 |
| Borax | 3.50 | 0.26 |
| Emulsogen EPA 073 | 12.00 | 0.91 |
| Emulsogen EPN 287 | 20.00 | 1.51 |
| Acetic acid (99-100%) | 1.40 | 0.11 |
| Initiator solution (1.17% strength | 59.40 | 4.5 |
| potassium peroxodisulfate solution) | | |
| Monomer mixture (initial charge) | 70.00 | 5.3 |

The emulsion is heated over the course of 30 minutes to 74 to 77° C. and held at that temperature for 15 minutes. Thereafter 630.00 g of monomer mixture are added with a metering rate of 4.49 ml/min over a time of 2 h 40 min and 85.61 g of initiator solution (1.17% strength potassium peroxodisulfate solution) are added with a metering rate of 0.51 ml/min over a time of 2 h 50 min, from two separate Dosimats (automatic metering devices). The reaction temperature is held at 80° C.

After the end of the metered addition of monomer and initiator the reaction temperature is maintained at 80° C. over 2 h. Thereafter the dispersion is cooled and at 40° C. is preserved with 2 g of ®Nipacide CFX 4 (product of Clariant GmbH). Tables 1, 2, 3 and 4 summarize the properties of the polymer dispersions.

Assessment: The polymerdispersion shows satisfactory results in all properties tested. The coagulum fractions and water absorption by the film are increased.

### Example 2 Tylose H 15 YG4/E 89906 (90/10; 90%)

Instead of 14 g of Tylose H 15 YG4 only 12.6 g of the mixture Tylose H 15 YG4/E 89906 (90/10) are used.

Assessment: The polymer dispersion shows satisfactory results in all properties tested. The water absorption is reduced, the particle size is reduced by about 13% and the amount of coagulum by about 10%.

### Example 3

### Tylose H 15 YG4/E 80201 (90/10; 90%)

Instead of 14 g of Tylose H 15 YG4 only 12.6 g of the mixture Tylose H 15 YG4/E 80201 (90/10) are used.

Assessment: The polymer dispersion shows satisfactory results in all properties tested. The water absorption is markedly reduced, the particle size is reduced by about 15% and the amount of coagulum by about 10%.

### Example 4

### Tylose H 15 YG4/E 80206 (90/10; 90%)

Instead of 14 g of Tylose H 15 YG4 only 12.6 g of the mixture Tylose H 15 YG4/E 80206 (90/10) are used.

Assessment: The polymer dispersion shows good results in all properties tested. The water absorption is markedly reduced, the particle size is reduced by about 15% and the amount of coagulum happily drastically by about 62%.

### Example 5 Standard Tylose H 200 YG4

Instead of 14 g of Tylose H 15 YG4 14 g of Tylose H 200 YG4 are used.

Assessment: The polymer dispersion shows satisfactory results in all properties tested. The coagulum fraction is reduced less compared with example 1, the particle size and the dispersion viscosity increased.

### Example 6 Tylose H 200 YG4/E 89906 (90/10; 90%)

Instead of 14 g of Tylose H 15 YG4 12.6 g of the mixture Tylose H 200 YG4/E 89906 (90/10) are used.

Assessment: The polymer dispersion shows satisfactory results in all properties tested and is stable not only to shearing but also to freeze/thaw. The amount of coagulum is reduced by about 38%, but the particle size is lowered surprisingly by about 27%, which goes hand-in-hand with an increase in viscosity.

### Example 7 Tylose H 200 YG4/E 80201 (90/10; 90%)

Instead of 14 g of Tylose H 15 YG4 12.6 g of the mixture Tylose H 200 YG4/E 80201 (90/10) are used.

Assessment: The polymer dispersion shows satisfactory results in all properties tested. Except for a slight reduction (about 15%) in the particle size the polymer dispersion is virtually identical to the dispersion from example 5.

### Example 8 Tylose H 15 YG4/E 80206 (90/10; 90%)

Instead of 14 g of Tylose H 15 YG4 only 12.6 g of the mixture Tylose H 15 YG4/E 80206 (90/10) are used.

Assessment: The polymer dispersion shows very good results in all properties tested. The amount of coagulum is happily reduced drastically by about 62%, with physical properties of the dispersion being otherwise virtually the same as those for example 5.

Additionally provided by the invention, and demonstrated by the following examples, is the fact that the products with higher degrees of allylation (DS_{allyl}>0.4), used “dilutedly” in blends with conventional HEC, lead to results whose quality is comparable with those for products in the DS_{allyl} range 0.01-0.04 (etherification target range DS_{allyl} 0.025-0.03). The dispersions additionally feature particular stability (freeze/thaw and shearing stability).

### Example 9 Standard Tylose E 89906 (50%)

Instead of 14 g of Tylose H 15 YG4 7 g of Tylose E 89906 (used here as standard for examples 10 to 13) with a DSallyl of 0.027 are used.

Assessment: The polymer dispersion shows good results in all properties tested.

### Example 10 with product 97/087C (50%)

Instead of 14 g of Tylose H 200 YG4 7 g of an allylglycidylhydroxyethylcellulose having a DS_{allyl} of 0.055 are used (product 97/087C).

Assessment: The results show that the more highly DS_{allyl}-etherified AM-HEC type can be used without mixing and for a given amount has distinct disadvantages as compared with standard Tylose E 89906. The coagulum fraction is approximately 440% higher than in example 9.

### Example 11 with Product 97/122C (50%)

Instead of 14 g of Tylose H 200 YG4 7 g of an allylglycidylhydroxyethylcellulose having a DS_{allyl} of 0.042 are used (product 97/122C).

Assessment: The results show that the more highly DS_{allyl}-etherified AM-HEC type can be used without mixing and for a given amount has distinct disadvantages as compared with standard Tylose E 89906. The coagulum fraction is approximately 175% higher than in example 9.

### Example 12 with Product 97/122C/H 200 YG4 (50/50; 50%)

Instead of 14 g of Tylose H 200 YG4 7 g of a mixture of allylglycidylhydroxyethylcellulose with a DS_{allyl} of 0.042 (97/122C)/Tylose H 200 YG4 (50/50) are used.

Assessment: In the mixture with Tylose H200 YG4 the more highly allylated allylglycidylhydroxyether cellulose leads to a dispersion having, surprisingly, properties just as good as that in example 9, and in fact the coagulum fraction falls by about 16%.

### Example 13 with Product 97/122C/H 200 YG4 (90/10; 90%)

Instead of 14 g of Tylose H 200 YG4 12.6 g of a mixture of allylglycidylhydroxyethylcellulose having a DS_{allyl} of 0.042 With Tylose H 200 YG4 (90/10) are used.

Assessment: The resuts show that the more highly DSallyl-etherified AM-HEC type, used as a mixture with Tylose H 200 YG4, produces dispersions whose quality is at least equal to that of the formulations from examples 2 to 4 and 6 to 8.

Below are examples with extreme mixing ratios AM-HEC/HEC (5/95, 95/5);

### Example 14 Tylose E 80206/H 200 YG4 (5/95; 90%)

Instead of 14 g of Tylose H 200 YG4 12.6 g of a mixture of Tylose E 89906/H 200 YG4 (5/95) are used.

Assessment: The polymer dispersion shows satisfactory results in all properties tested. The reduction of the AM-HEC component (Tylose E 89906) in the mixture to 95/5 as compared with the mixture in example 6 (90/10) alters the properties of the dispersion and leads to a slight increase in coagulum; the particle size becomes coarser and the viscosity of the dispersion is reduced.

### Example 15 Tylose E 89906/H 200 YG4 (95/5; 50%)

Instead of 14 g of Tylose H 200 YG4 7 g of a mixture of Tylose E 89906/H 200 YG4 (95/5) are used.

Assessment: The results show that the 5% admixing of Tylose H 200 YG4 to E 89906 produces a dispersion of higher quality than the comparable formulation from example 9 containing exclusively Tylose E 89906. The water absorption is lower by 15% and the coagulum by 41%.

There now follow examples using AM-HEC with an increased viscosity level (3000 and 10,000 mPas) in a mixture with HEC:

### Example 16 Tylose KR 011/00 (50%)

Instead of 14 g of Tylose H 200 YG4 7 g of an AM-HEC having a viscosity of 3000 mPas are used.

Assessment: The dispersion displays good stability but a slight increase in coagulum (175 mg/000 g of dispersion).

### Example 17 Tylose KR011/00/H 180 YG4 (50/50; 50%)

Instead of 14 g of Tylose H 200 YG4 7 g of a mixture of AM-HEC of viscosity 3000 mPas and Tylose H 180 YG4 are used.

Assessment: Starting from the 2nd cycle the dispersion is not stable to freeze/thaw but is stable to shearing. As a result of the fractional replacement by H 180 YG4 the amount of coagulum has reduced happily to half as compared with example 16.

### Example 18 Tylose KR012/00 (50%)

Instead of 14 g of Tylose H 200 YG4 7 g of an AM-HEC having a viscosity of 10,000 mPas are used.

Assessment: The dispersion displays good stability but an increase in coagulum (244 mg/1000 g of dispersion).

### Example 19 Tylose KR012/00/H 180 YG4 (60/40; 50%)

Instead of 14 g of Tylose H 200 YG4 7 g of a mixture of AM-HEC of viscosity 10,000 mPas and Tylose H 180 YG4 are used (60/40).

Assessment: The dispersion is stable both to freeze/thaw and to shearing. As compared with example 18 the amount of coagulum, as a result of the fractional replacement by H 180 YG4, has reduced happily to about ⅓ (100 μm) or about ½ (40 μm). The viscosity is situated within the practicable range (9700 mPas).

### Example 20 Tylose KR012/00/H 180 YG4 (50/50; 50%)

Instead of 14 g of Tylose H 200 YG4 7 g of a mixture of AM-HEC of viscosity 10,000 mPas and Tylose H 180 YG4 are used (50/50).

Assessment: The dispersion is stable both to freeze/thaw and to shearing. As compared with example 18 the amount of coagulum, as a result of the fractional replacement by H 180 YG4, has reduced happily to 50%. Also evident is the considerable influence on viscosity exerted by playing on the mixing ratio. In comparison to example 19 the viscosity has increased to almost twice the amount, but is situated at the same level as example 17.

TABLE 3

| | | | | | | Coagulum > | Coagulum | |
|---|---|---|---|---|---|---|---|---|
| Protective | | Amount | Mixing | Particle size | Particle size | 100 μm | 100 − 40 μm | Viscosity at |
| colloid | Ex. | used | ratio | [nm] at λ = | [nm] at λ = | [mg/1000 g | [mg/1000 g | 1 s |
| Tylose | No. | [%] | [pbw] | 435 nm | 588 nm | dispersion] | dispersion] | [mPas] |
| H 15 YG4 | 1 | 1.06 | — | 314 | 368 | 141 | 157 | 9590 |
| H 15 YG4/ | 2 | 0.95 | 90/10 | 275 | 315 | 139 | 128 | 12880 |
| E 89906 | | | | | | | | |
| H 15 YG4/ | 3 | 0.95 | 90/10 | 265 | 307 | 100 | 169 | 14520 |
| E 80201 | | | | | | | | |
| H 15 YG4/ | 4 | 0.95 | 90/10 | 273 | 304 | 65 | 48 | 15590 |
| E 80206 | | | | | | | | |
| H 200 YG4 | 5 | 1.06 | — | 329 | 397 | 90 | 105 | 13860 |
| H 200 YG4/ | 6 | 0.95 | 90/10 | 243 | 289 | 80 | 45 | 16120 |
| E 89906 | | | | | | | | |
| H 200 YG4/ | 7 | 0.95 | 90/10 | 280 | 336 | 112 | 63 | 14440 |
| E 80201 | | | | | | | | |
| H 200 YG4/ | 8 | 0.95 | 90/10 | 314 | 368 | 80 | 23 | 11680 |
| E 80206 | | | | | | | | |
| E 89906 | 9 | 0.53 | — | 310 | 342 | 107 | 24 | 11580 |
| 97/087C | 10 | 0.53 | — | 344 | 406 | 181 | 488 | 13000 |
| 97/122C | 11 | 0.53 | — | 345 | 401 | 120 | 160 | 9950 |
| H 200 YG4/ | 12 | 0.53 | 50/50 | 311 | 344 | 72 | 32 | 10770 |
| 97/122C | | | | | | | | |
| H 200 YG4/ | 13 | 0.95 | 90/10 | 266 | 318 | 133 | 94 | 16330 |
| 97/122C | | | | | | | | |
| E 89906/ | 14 | 0.95 | 5/95 | 288 | 342 | 82 | 84 | 10150 |
| H 200 YG4 | | | | | | | | |
| E 89906/ | 15 | 0.53 | 95/5 | 299 | 328 | 38 | 39 | 10500 |
| H 200 YG4 | | | | | | | | |

TABLE 4

| Protective | | Amount | Mixing | | Freeze/ | Water |
|---|---|---|---|---|---|---|
| colloid | Ex. | used | ratio | Shear | thaw | absorption |
| Tylose | No. | [%] | [pbw] | stability | stability | [%] |
| H 15 YG4 | 1 | 1.06 | — | stable | stable | 25.3 |
| H 15 YG4/ | | 0.95 | 90/10 | stable | unstable | 20.3 |
| E 89906 | | | | | | |
| H 15 YG4/ | 3 | 0.95 | 90/10 | stable | unstable | 18.8 |
| E 80201 | | | | | | |
| H 15 YG4/ | 4 | 0.85 | 90/10 | stable | unstable | 20.6 |
| E 80201 | | | | | | |
| H 15 YG4/ | 5 | 0.95 | 90/10 | stable | unstable | 21.9 |
| E 80206 | | | | | | |
| H 200 YG4 | 6 | 1.06 | — | stable | unstable | 22.1 |
| H 200 YG4/ | 8 | 0.95 | 90/10 | stable | stable | 22.8 |
| E 89906 | | | | | | |
| H 200 YG4/ | 9 | 0.95 | 90/10 | stable | unstable | 21.2 |
| E 80201 | | | | | | |
| H 200 YG4/ | 10 | 0.95 | 90/10 | stable | unstable | 23.5 |
| E 80206 | | | | | | |
| E 89906 | 11 | 0.53 | — | stable | stable | 20.4 |
| 97/087C | 12 | 0.53 | — | stable | stable | 25.6 |
| 97/122C | 13 | 0.53 | — | stable | stable | 24.1 |
| H 200 YG4/ | 14 | 0.53 | 50/50 | stable | stable | 21.3 |
| 97/122C | | | | | | |
| H 200 YG4/ | 15 | 0.95 | 90/10 | stable | unstable | 25.0 |
| 97/122C | | | | | | |
| E 89906/ | 14 | 0.95 | 5/95 | stable | stable | 22.0 |
| H 200 YG4 | | | | | | |
| E 89906/ | 15 | 0.53 | 95/5 | stable | stable | 17.4 |
| H 200 YG4 | | | | | | |

TABLE 5

| | | | | | | Coagulum > | Coagulum | |
|---|---|---|---|---|---|---|---|---|
| Protective | | Amount | Mixing | Particle size | Particle size | 100 μm | 100 − 40 μm | Viscosity at |
| colloid | Ex. | used | ratio | [nm] at λ = | [nm] at λ = | [mg/1000 g | [mg/1000 g | 1 s |
| Tylose | No. | [%] | [pbw] | 435 nm | 588 nm | dispersion] | dispersion] | [mPas] |
| KR 011/00 | 16 | 0.53 | — | — | 383 | 107 | 68 | 13460 |
| KR 011/00/ | 17 | 0.53 | 50/50 | — | 288 | 49 | 38 | 18960 |
| H 180 YG4 | | | | | | | | |
| KR 011/00 | 18 | 0.53 | — | — | 375 | 170 | 74 | 14470 |
| KR 011/00/ | 19 | 0.53 | 60/40 | — | 323 | 54 | 34 | 9700 |
| H 180 YG4 | | | | | | | | |
| KR 011/00/ | 20 | 0.53 | 50/50 | — | 313 | 63 | 58 | 18810 |
| H 180 YG4 | | | | | | | | |

TABLE 6

| Protective | | Amount | Mixing | | Freeze/ |
|---|---|---|---|---|---|
| colloid | Ex. | used | ratio | Shear | thaw |
| Tylose | No. | [%] | [pbw] | stability | stability |
| KR 011/00 | 16 | 0.53 | — | stable | stable |
| KR 011/00/ | 17 | 0.53 | 50/50 | stable | unstable |
| H 180 YG4 | | | | | |
| KR 011/00 | 18 | 0.53 | — | stable | stable |
| KR 011/00/ | 19 | 0.53 | 60/40 | stable | stable |
| H 180 YG4 | | | | | |
| KR 011/00/ | 20 | 0.53 | 50/50 | stable | stable |
| H 180 YG4 | | | | | |

Determining the Degree of Polymerization of Cellulose Ethers

For the purposes of the present invention degrees of polymerization of cellulose ethers are to be determined by the following method.

According to Staudinger there is a linear relation, for linear macromolecules, between the specific viscosity of the sol solution (η_{spec}≦0.3) and the degree of polymerization and/or molecular weight. On this basis the average value DP_{visc} is determined by measuring the viscosity of highly dilute cellulose ether solutions.

In this context the limiting viscosity number is determined by a measurement on dilute aqueous cellulose ether solutions using an Ubbelohde capillary viscometer (for manual absolute measurements, in accordance with ISO/DIN 51562, DIN 51562-1 (part 1): design and implementation of measurement) with capillary 0c, and the degree of polymerization is calculated from this.

Formal Relationship in Detail:

For linear polymers there exists between the specific viscosity (η_{spec}) of sufficiently dilute solutions (sol solution; η_{spec}≦0.3) and the mean degree of polymerization (\overline{DP}_{visc}) and/or the mean molecular weight (\overline{M}_{visc} in g-mol⁻¹) the following linear relationship:
η_{spec}=Kₘ·c·\overline{DP}_{visc} . . . (1)
η_{spec}=Kₘ·C_{gm}·\overline{M}_{visc} . . . (2)
where Kₘ is a specific constant in cm³·g ⁻¹ and c is the concentration of the polymer in g·cm⁻³ or C_{gm} the concentration of the monomer unit in mol·cm⁻³.

In this context η_{spec} can be calculated from the reduced viscosity

$$( {η}_{r} = \frac{{t}_{soln}}{{t}_{solv}} )$$

as follows:

$${η}_{spec} = \frac{{t}_{soln} - {t}_{solv}}{{t}_{solv}} = \frac{{t}_{soln}}{{t}_{solv}} - 1 = {η}_{r} - 1 [ \text{-} \text{-} \text{-} ] \qquad ( 3 )$$

where tₛₒₗₙ and tₛₒₗᵥ are the capillary transit times of solution and solvent (in this case water).

The variable η_{spec}/c or η_{spec}/c_{gm} is called reduced specific viscosity or viscosity number (η_{red}).

$$\begin{matrix}\frac{{η}_{spec}}{c} = {η}_{red} = {K}_{m} \cdot {\overline{DP}}_{visc } [ {cm}^{3} \cdot {g}^{- 1} ] & ( 4 ) \\ \frac{{η}_{spec}}{{c}_{gm}} = {η}_{red}^{′} = {K}_{m} \cdot {\overline{M}}_{visc } [ {cm}^{3} \cdot {mol}^{- 1} ] & ( 5 )\end{matrix}$$

At sufficiently low concentration and low shear rate the reduced specific viscosity is a characteristic product constant which is referred to as the “Staudinger index” or “limiting viscosity number” (or “intrinsic viscosity”) ([η]).

$$lim \frac{{η}_{spec}}{c} = [ η ] = {K}_{m} \cdot {\overline{DP}}_{visc } [ {cm}^{3} \cdot {g}^{- 1} ] \\ c \to 0 \\ D \to 0 \qquad ( 6 )$$

The determination of c→0 by means for example of graphic methods (η_{spec}/c against c or η_{spec}/C against η_{spec}) or by the Heβ-Philippoff method (Hess, K. and Philippoff, M. Ber. dtsch. chem. Ges. 70, 639 (1937)) (at only one concentration) is omitted in the case of the measurement conditions in the sol range.

Starting from about \overline{DP}_{visc}≧400 (corresponding to a viscosity level of approximately 100 mPa·s) it is necessary to take account of the shear rate (D in s⁻¹) which is present under the Ubbelohde conditions, since then the requirement D→0 is no longer met to a sufficient extent.

This can be effected by the method of Rodriguez and Goettler (Rodriguez, F. and Goettler, L. A., Transactions of the Society of Rheology VIII, 3-17 (1964), “The Flow of Moderately Concentrated Polymer Solutions in Water”) by recording a flow curve using an absolute viscometer. In this case a correction factor is determined, which is referred to as “structural viscosity” (shear thinning) and abbreviated below to ηₛₜ₃. The relationship is as follows:

$${η}_{st3} = \frac{log {η}_{{E}_{d}}}{log {η}_{N}} [ \text{-} \text{-} \text{-} ] \qquad ( 7 )$$

with the viscosity ηE_{_{d}} for the dissipated energy Ed as present during the measurement by the Ubbelohde method, and the zero-shear viscosity η_{N}.

Using capillary 0c and a transit time D of around 400 s, E_{d} is approximately 10³ Pa·s⁻¹. This is given by the flow volume V and the capillary radius R as follows:

$$\begin{matrix}D = \frac{8 \cdot V}{3 \cdot π \cdot {R}^{3} \cdot D} = \frac{370850}{D} [ {s}^{- 1} ] & ( 8 ) \\ {E}_{d} = \frac{{η}_{r} \cdot {D}^{2}}{1000} [ Pa \cdot {s}^{- 1} ] & ( 9 )\end{matrix}$$

The relative viscosity (η_{rN}) for a shear rate (and a concentration) toward 0 is obtained by means of the structural factor as follows:

$$log {η}_{rN} = \frac{log {η}_{r}}{{η}_{st3}} or {η}_{rN} = {10}^{\frac{log {η}_{r}}{{η}_{st3}}} [ \text{-} \text{-} \text{-} ] \qquad ( 10 )$$

The corresponding specific viscosity (η_{spec,N}) at a shear rate and concentration toward 0 is then:
η_{spec,N}=η_{rN}−1 . . . (11)

Consequently the limiting viscosity number is:

$$[ η ] = \frac{{η}_{rN} - 1}{c} = \frac{{η}_{spec , N}}{c} [ {cm}^{3} \cdot {g}^{- 1} ] \qquad ( 12 )$$

This gives, finally, the average degree of polymerization (\overline{DP}_{visc}) as follows:

$${\overline{DP}}_{visc } = \frac{[ η ]}{{K}_{m}} = \frac{[ η ]}{1.1} [ \text{-} \text{-} \text{-} ] \qquad ( 13 )$$

1. A mixture of cellulose ethers, comprising
A) allyl-modified cellulose ethers of formula (1)
[C₆H₇O₂(OR¹)(OR²)(OR³)]n (1)
where
C₆H₇O₂ is one anhydroglucose unit
n is from 50 to 1600
R¹, R² and R³ independently of one another are a polyalkylene oxide chain of the formula (2) 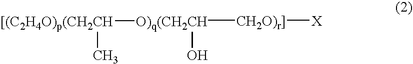
where X=H, CH₃, C₂H₅ or CH₂CH═CH₂
and in which
p, q and r independently of one another, in R¹, R² and R³ each independently, can adopt values from 0 to 4, the sum (p+q+r) added over R¹, R² and R³ per anhydroglucose unit is on average more than 1.3 and less than 4.5, the sequence of the oxyalkyl units in the polyalkylene oxide chain is arbitrary and the average number of —CH₂CH═CH₂— groups per anhydroglucose unit is from 0.01 to 0.1, and
B) cellulose ethers of formula (3)
[C₆H₇O₂(OR⁴)(OR⁵)(OR⁶)]n (3)
where
C₆H₇O₂ is one anhydroglucose unit,
n is from 50 to 1600,
R⁴, R⁵ and R⁶ independently of one another are a polyalkylene oxide chain of formula (4) 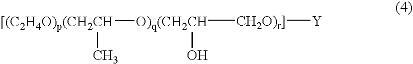
where Y=H, CH₃ or C₂H₅ and in which
p, q and r independently of one another, in R⁴, R⁵ and R⁶ each independently, can adopt values of 0 to 4, the sum (p+q+r) added over R⁴, R⁵ and R⁶ per anhydroglucose unit is on average more than 1.3 and less than 4.5, and the sequence of the oxyalkyl units in the polyalkylene oxide chain is arbitrary, in an A:B mixing ratio of from 1:99 to 99:1 by weight.

2. The mixture of cellulose ethers as set forth in claim 1, wherein n is a number from 100 to 700.

3. The mixture of cellulose ethers as set forth in claim 1, wherein (p+q+r) is from 1.5 to 3.0.

4. The mixture of cellulose ethers as set forth in claim 1, wherein the average number of allyl groups per anhydroglucose unit in the allyl-modified cellulose ethers of formula (1) is from 0.02 to 0.04.

5. (canceled)

6. The mixture of cellulose ethers as set forth in claim 2, wherein (p+q+r) is from 1.5 to 3.0.

7. The mixture of cellulose ethers as set forth in claim 2, wherein the average number of allyl groups per anhydroglucose unit in the allyl-modified cellulose ethers of formula (1) is from 0.02 to 0.04.

8. The mixture of cellulose ethers as set forth in claim 3, wherein the average number of allyl groups per anhydroglucose unit in the allyl-modified cellulose ethers of formula (1) is from 0.02 to 0.04.

9. The mixture of cellulose ethers as set forth in claim 6, wherein the average number of allyl groups per anhydroglucose unit in the allyl-modified cellulose ethers of formula (1) is from 0.02 to 0.04.

10. A process for emulsion polymerization which comprises free-radically polymerizing an ethylenically unsaturated monomer with from 0.2 to 5% by weight of the monomers of a mixture of cellulose ethers of claim 1.

11. A process for emulsion polymerization which comprises free-radically polymerizing an ethylenically unsaturated monomer with from 0.2 to 5% by weight of the monomers of a mixture of cellulose ethers of claim 2.

12. A process for emulsion polymerization which comprises free-radically polymerizing an ethylenically unsaturated monomer with from 0.2 to 5% by weight of the monomers of a mixture of cellulose ethers of claim 3.

13. A process for emulsion polymerization which comprises free-radically polymerizing an ethylenically unsaturated monomer with from 0.2 to 5% by weight of the monomers of a mixture of cellulose ethers of claim 4.

14. A process for emulsion polymerization which comprises free-radically polymerizing an ethylenically unsaturated monomer with from 0.2 to 5% by weight of the monomers of a mixture of cellulose ethers of claim 5.

15. A process for emulsion polymerization which comprises free-radically polymerizing an ethylenically unsaturated monomer with from 0.2 to 5% by weight of the monomers of a mixture of cellulose ethers of claim 6.

16. A process for emulsion polymerization which comprises free-radically polymerizing an ethylenically unsaturated monomer with from 0.2 to 5% by weight of the monomers of a mixture of cellulose ethers of claim 7.

17. A process for emulsion polymerization which comprises free-radically polymerizing an ethylenically unsaturated monomer with from 0.2 to 5% by weight of the monomers of a mixture of cellulose ethers of claim 8.

18. A process for emulsion polymerization which comprises free-radically polymerizing an ethylenically unsaturated monomer with from 0.2 to 5% by weight of the monomers of a mixture of cellulose ethers of claim 9.

19. The process of claim 10 wherein the ethylenically unsaturated monomer is selected from the group consisting of water insoluble ethylenically unsaturated hydrocarbons having chain lengths of 2 to 12 carbon atoms; esters having chain lengths of between 2 and 12 carbon atoms of acrylic acid, methacrylic acid, maleic acid, fumaric acid and itaconic acid; ethylenically unsaturated aromatic compounds; halogenated ethylenically unsaturated compounds, vinyl esters of unbranched and branched carboxylic acids having chain lengths of 1 to 12 carbon atoms, ethylenically unsaturated aldehydes having 3 to 12 carbon atoms, ethylenically unsaturated ketones having 3 to 23 carbon atoms, and mixtures thereof.

20. The process of claim 10 wherein the ethylenically unsaturated monomer is selected from the group consisting of ethylene, propylene; ethyl, propyl and butyl ester of acrylic acid; ethyl, propyl and butyl ester of methacrylic acid; ethyl, propyl and butyl ester of maleic acid; ethyl, propyl and butyl ester of fumaric acid; ethyl, propyl and butyl ester of itaconic acid; vinyl acetate and versatic acid vinyl esters, styrene; acrolein, methacrolein, methyl vinyl ketone, vinyl chloride and mixtures thereof.
